(19) United States
(12) Patent Application Publication
(10) Pub. No.: US 2021/0322964 A1
(43) Pub. Date: Oct. 21, 2021

(54) CATALYST MEMBER AND REACTOR

(71) Applicant: NGK INSULATORS, LTD., Nagoya-shi (JP)

(72) Inventors: Kazuki IIDA, Nagoya-shi (JP); Makoto IWAI, Kasugai-shi (JP)

(21) Appl. No.: 17/360,498

(22) Filed: Jun. 28, 2021

Related U.S. Application Data
(63) Continuation of application No. PCT/JP2020/002415, filed on Jan. 23, 2020.

(30) Foreign Application Priority Data
Mar. 11, 2019 (JP) 2019-044130

(51) Int. Cl. B01J 35/04; B01J 35/00; B01J 37/02; B01J 8/00; B01J 8/06

(52) U.S. Cl. CPC B01J 35/04; B01J 35/0033; B01J 37/0236; B01J 8/06; B01J 8/008; B01J 35/0006; B01J 37/0209

(57) ABSTRACT

A catalyst member 10 includes: a support 11; a polarization layer 12 provided on the support 11; and a catalyst layer 13 provided on the polarization layer 12. Further, a reactor includes the catalyst member 10.

### CROSS-REFERENCE TO RELATED APPLICATIONS

This is a continuation of PCT/JP2020/002415, filed Jan. 23, 2020, which claims priority to Japanese Application No. JP2019-044130 filed on Mar. 11, 2019, the entire contents of which are hereby incorporated by reference.

### FIELD OF THE INVENTION

The present invention relates to a catalyst member and a reactor. More particularly, the present invention relates to a catalyst member and a reactor used for synthesis of compounds employed for pharmaceuticals, fragrances and the like.

### BACKGROUND OF THE INVENTION

Synthesis of compounds is generally carried out by using a batch method of charging raw materials, a catalyst and the like into a reactor to react, and removing a reaction product when the reaction is completed. The batch method can synthesize compounds having a complicated structure used for pharmaceuticals, fragrances, and the like, while it causes problems of lower productivity and the like because it requires separation and recovery of the catalyst from the reaction product.

Therefore, attention is focused on a flow method of continuously charging raw materials from one end of a reactor and continuously discharging a reaction product from the other end of the reactor. For example, Non-Patent Literature 1 proposes a method of carrying out a reaction by circulating a mixture containing raw materials and a liquid catalyst in a tubular reactor. Further, Patent Literature 1 proposes a method of carrying out a reaction by circulating raw materials in reactors (microchannels) in which a catalyst is supported on supports forming flow paths for the raw materials.

### CITATION LIST

### Patent Literatures

[Patent Literature 1] WO 2007/111997 A1
[Non-Patent Literature] Martin D. Johnson, et al, “Design and Comparison of Tubular and Pipes-in-Series Continuous Reactors for Direct Asymmetric Reductive Amination”, Organic Process Research & Development, Vol. 20, pp. 1305-1320, 2016

### SUMMARY OF THE INVENTION

A catalyst member according to one aspect of the present invention comprises: a support; a polarization layer provided on the support; and a catalyst layer provided on the polarization layer.

In one embodiment of the catalyst member according to one aspect of the present invention, the polarization layer is formed of a dielectric substance.

In another embodiment of the catalyst member according to one aspect of the present invention, the catalyst layer comprises a catalyst having a metal.

In another embodiment of the catalyst member according to one aspect of the present invention, the catalyst is a metal complex catalyst.

In another embodiment of the catalyst member according to one aspect of the present invention, the metal complex catalyst is an asymmetric catalyst.

In another embodiment of the catalyst member according to one aspect of the present invention, the support is formed of a ceramic.

In another embodiment of the catalyst member according to one aspect of the present invention, the support is translucent, and a part of the support does not comprise the polarization layer and the catalyst layer.

In another embodiment of the catalyst member according to one aspect of the present invention, at least a part of the support, the polarization layer and the catalyst layer is translucent.

In another embodiment of the catalyst member according to one aspect of the present invention, the support is partition walls of a honeycomb structure.

A reactor according to another aspect of the present invention comprises the catalyst member as described above.

In one embodiment, the reactor according to another aspect of the present invention further comprises a container for containing the catalyst member.

In another embodiment of the reactor according to another aspect of the present invention, at least a part of the container is translucent.

In another embodiment of the reactor according to another aspect of the present invention, the support of the catalyst member is partition walls of a honeycomb structure, and the container is a tubular container covering an outer peripheral wall of the honeycomb structure.

In another embodiment, the reactor according to another aspect of the present invention is used for flow synthesis.

### BRIEF DESCRIPTION OF THE DRAWINGS

FIG. 1 is a cross-sectional view of a catalyst member according to Embodiment 1 of the present invention;

FIG. 2 is a cross-sectional view of a catalyst member according to Embodiment 2 of the present invention;

FIG. 3 is a perspective view of a catalyst member according to Embodiment 3 of the present invention;

FIG. 4 is a cross-sectional view of a catalyst member according to Embodiment 3 of the present invention; and

FIG. 5 is a cross-sectional view of a reactor according to Embodiment 4 of the present invention.

### DETAILED DESCRIPTION OF THE INVENTION

However, the method of Non-Patent Literature 1 uses the liquid catalyst, and it is, therefore, necessary to separate and recover the liquid catalyst from the reaction product after the reaction.

Further, the method of Patent Literature 1 results in a little release of the catalyst from the supports in a gas reaction, whereas it results in easy separation of the catalyst from the supports in a liquid reaction, so that the catalyst may be contaminated in the reaction product. Therefore, this method may also have to separate and recover the catalyst from the reaction product. In addition, a reaction efficiency decreases as the catalyst is released from the support, so that replacement of the reactor will be required.

The present invention has been made to solve the above problems. An object of the present invention is to provide a catalyst member and a reactor which are difficult to release a catalyst from a support and which do not require separation and recovery of the catalyst from a reaction product.

As a result of intensive studies to solve the above problems, the present inventors have found that a catalyst layer can be firmly fixed to a support by providing a polarization layer between the support and the catalyst layer, and have completed the present invention.

According to the present invention, it is possible to provide a catalyst member and a reactor which are difficult to release a catalyst from a support and which do not require separation and recovery of the catalyst from a reaction product.

Hereinafter, embodiments according to the present invention will be specifically described with reference to the drawings. It is to understand that the present invention is not limited to the following embodiments, and various modifications and improvements, which will be within the scope of the present invention, may be made based on ordinary knowledge of a person skilled in the art, without departing from the spirit of the present invention.

### Embodiment 1

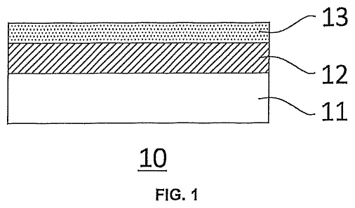

FIG. 1 is a cross-sectional view of a catalyst member according to Embodiment 1 of the present invention. As shown in FIG. 1, a catalyst member 10 according to Embodiment 1 of the present invention includes: a support 11, a polarization layer 12 provided on the support 11; and a catalyst layer 13 provided on the polarization layer 12.

A material and shape of the support 11 are not particularly limited as long as they do not inhibit a reaction.

Examples of the material of the support 11 include ceramics, metals, silica, polyethylene, polystyrene and the like. Among them, the material of the support 11 is preferably the ceramics in terms of adhesion to the polarization layer 12 (particularly, the polarization layer 12 formed of a dielectric substance). Non-limiting examples of the ceramics include zirconia, cordierite, zeolite, and alumina.

The support 11 preferably has a thermal conductivity of 2 W/m·K or more. The thermal conductivity of the support 11 of 2 W/m·K or more leads to dissipation of heat to the outside through the support 11 when the reaction is an exothermic reaction, so that it is difficult to accumulate the heat in a reactor provided with the catalyst member 10. Therefore, any excessive progress of the reaction can be suppressed, thereby facilitating reaction control.

Examples of the shape of the support 11 include a honeycomb shape, a foam shape, a monolith shape, a corrugated shape, and the like. Among them, the shape of the support 11 is preferably the honeycomb shape. The honeycomb-shaped support 11 has a higher specific surface area, so that the reaction efficiency can be improved and the size of the catalyst member 10 can be reduced. These shapes can be obtained by an extrusion molding method or a mold cast molding method.

The polarization layer 12 is not particularly limited as long as it is formed of a material capable of electric polarization. Examples of the material capable of electric polarization that can be used include dielectric substances. Among them, it is preferable to use a ferroelectric substance in which deviation of electric charges (spontaneous polarization) occurs even in the natural state.

Examples of the ferroelectric substance include lithium niobate (LiNbO₃), lithium tantalate (LiTaO₃), barium titanate (BaTIO₃), lead zirconate titanate (PbZrTiO₃; PZT), and PLZT having a part of lead of PZT substituted with lanthanum La, and the like.

The polarization layer 12 is preferably polarized with a positive charge on the support 11 side and a negative charge on the catalyst layer 13 side. The polarization layer 12 thus polarized can be bonded to the catalyst layer 13 having a positive charge by electrostatic interaction, so that it is difficult to release the catalyst layer 13 from the polarization layer 12.

The polarization layer 12 is preferably an orientational polarization layer having aligned crystal orientations (crystal axes) in one direction. Since the orientational polarization layer has a dense structure, the catalyst layer 13 can be satisfactorily formed on the orientational polarization layer. Further, the orientational polarization layer can be supported while maintaining chirality of an asymmetric catalyst used as a catalyst for the catalyst layer 13.

The catalyst layer 13 is not particularly limited and may be a layer formed of a known catalyst. A type of the catalyst may be appropriately selected depending on a type of reaction in which the catalyst member 10 is used, and is not particularly limited.

The catalyst preferably has a metal in view of a binding force to the polarization layer 12. Since the catalyst having a metal has a positive charge and can be bonded to the surface of the polarization layer 12 polarized with a negative charge by electrostatic interaction, the catalyst layer 13 is difficult to be released from the polarization layer 12.

Examples of the catalyst having the metal include precious metals such as platinum and palladium, iron oxide and the like. Further, a noble metal supported on a support such as activated carbon and silica gel may be used as a catalyst. Further, a metal complex catalyst having a ligand bonded to a metal ion, particularly an asymmetric catalyst having an asymmetric ligand, may be used as a catalyst. The use of such a catalyst can allow a compound having a complicated structure (for example, a compound having at least one asymmetric atom) to be synthesized. Examples of the asymmetric catalyst include those having an asymmetric ligand such as BINAP bonded to a metal ion such as ruthenium, rhodium, and palladium.

The catalyst member 10 having the above structure can be produced by sequentially forming the polarization layer 12 and the catalyst layer 13 on the support 11.

The method for forming the polarization layer 12 is not particularly limited, and can be carried out according to a known method. For example, the polarization layer 12 can be formed by using a hydrothermal synthesis method or the like. The polarization layer 12 may be optionally subjected to a polarization process of applying a high voltage in order to align the directions of polarization.

The method for forming the catalyst layer 13 is not particularly limited, and can be carried out according to a known method. For example, the catalyst layer 13 can be formed by applying a solution of the catalyst dissolved or dispersed onto the polarization layer 12 and drying the solution.

In the catalyst member 10 produced as described above, the polarization layer 12 and the catalyst layer 13 are bonded by electrostatic interaction, so that the catalyst layer 13 is firmly fixed to the polarization layer 12. Therefore, in the catalyst member 10, the catalyst layer 13 is difficult to be separated from the polarization layer 12, so that the catalyst can be prevented from being contaminated in the reaction product, and the catalyst function is difficult to be deteriorated.

### Embodiment 2

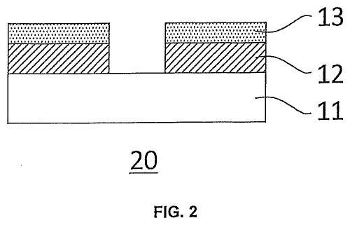

FIG. 2 is a cross-sectional view of a catalyst member according to Embodiment 2 of the present invention. The same components as those of the catalyst member 10 according to Embodiment 1 of the present invention are designated by the same reference numerals, and descriptions of duplicate portions will be omitted.

As shown in FIG. 2, in a catalyst member 20 according to Embodiment 2 of the present invention, a part of the support 11 does not include the polarization layer 12 and the catalyst layer 13. Further, the support 11 is translucent.

Such a configuration can allow a reaction status on the catalyst layer 13 side to be confirmed via the support 11.

As used herein, “translucent” means that a linear transmittance is 20% or more when measuring a linear transmittance of visible light, particularly light having a wavelength of from 400 to 700 nm for a sample having a thickness of 0.5 mm. The linear transmittance is preferably 30% or more, and more preferably 40% or more, and still more preferably 50% or more. The linear transmittance of light can be measured using a spectrophotometer (LAMBDA 900 ultraviolet visible near infrared spectrophotometer from PerkinElmer).

Non-limiting examples of a material of the translucent support 11 include translucent ceramics containing zirconia or alumina as a main component, quartz glass, and the like. Examples of the translucent ceramic containing zirconia as a main component include translucent zirconia made of cubic yttria stabilized zirconia (YSZ). The translucent zirconia has a linear transmittance of about 25% and a thermal conductivity of 3 W/m·K. Further, examples of the translucent ceramic containing alumina as a main component include translucent alumina made of high-purity alumina. The translucent alumina has a linear transmittance of about 50% and a thermal conductivity of 38 W/m·K.

Further, even if the polarization layer 12 and the catalyst layer 13 are provided on the entire support 11, the reaction status on the catalyst layer 13 side can be confirmed via the support 11 if at least a part of the support 11, the polarization layer 12 and the catalyst layer 13 is translucent.

Non-limiting examples of the translucent polarization layer 12 include layers formed of transparent dielectric substances such as PLZT, gallium nitride, and aluminum nitride. The polarization layer 12 may be a single crystal or a polycrystal, but it preferably has the crystal oriented on an axis having a larger polarization. Since all of the above three materials exemplified have polarization on the c-axis, it preferably has c-axis orientation. When a material having polarization on the a-axis is used, a-axis orientation is preferable.

The translucent catalyst layer 13 is not particularly limited, and may be a layer that can be formed of a translucent catalyst, or the translucency may be ensured by decreasing an amount of adhesion of the catalyst (that is, reducing the thickness of the catalyst layer 13).

### Embodiment 3

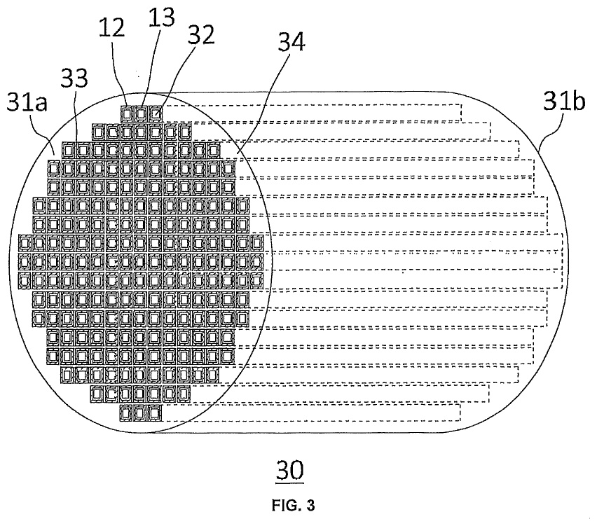

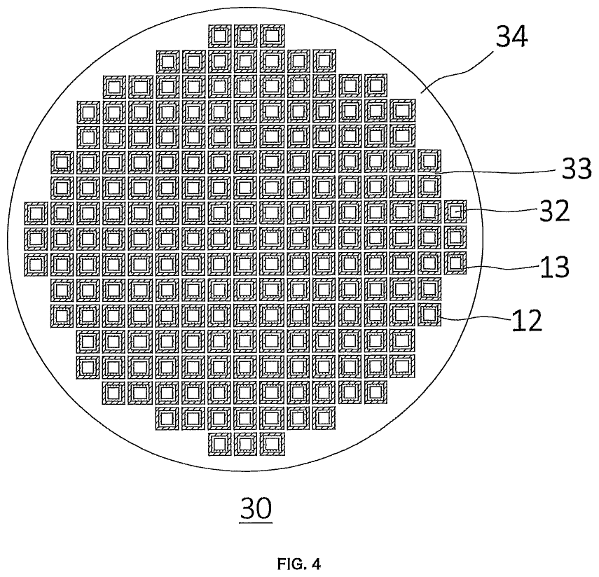

FIG. 3 is a perspective view of a catalyst member according to Embodiment 3 of the present invention. Further, FIG. 4 is a cross-sectional view (cross-sectional view perpendicular to a cell extending direction) of the catalyst member according to Embodiment 3 of the present invention. The same components as those of the catalyst members 10, 20 according to Embodiments 1 and 2 of the present invention are designated by the same reference numerals, and descriptions of duplicate portions will be omitted. Further, in FIG. 3, internal structures observed by permeation from the outer surface is represented by dotted lines.

As shown in FIGS. 3 and 4, in a catalyst member 30 according to Embodiment 3 of the present invention, the support 11 is honeycomb-shaped, that is, partition walls 33 of a honeycomb structure. More particularly, the catalyst member 30 includes: the partition walls 33 that define a plurality of cells 32 extending from a fluid inflow end face 31a to a fluid outflow end face 31b; polarization layers 12 provided on the partition walls 33; and catalyst layers 13 provided on the polarization layers 12. Since an outer peripheral surface of the catalyst member 30 is surrounded by an outer peripheral wall 34, the catalyst member 30 itself can be used as a reactor.

The cross section perpendicular to the extending direction of the cells 32 of the honeycomb structure may have various shapes including, but not limited to, a circle, an ellipse, a triangle, a quadrangle, a hexagon, and an octagon. Among them, the shape of the honeycomb structure is preferably circular.

A size of the honeycomb structure is not particularly limited, and it may be appropriately adjusted depending on a type and scale of the reaction.

Shapes of the cells 32 (shapes of the cells 32 in the cross section perpendicular to the extending direction of the cells 32) may be various shapes including, but not limited to, a circle, an ellipse, a triangle, a quadrangle, a hexagon, and an octagon. Among them, the shape of each cell 32 is preferably a quadrangle (square or rectangle).

A size of each cell 32 is not particularly limited, but each cell 32 in the cross section perpendicular to the extending direction of the cells 32 may preferably have a diameter of from 1 to 3 mm, and more preferably from 1.5 to 2.5 mm. The diameter of each cell 32 of 1 mm or more can increase an amount of a raw material that can be fed into the cells 32. Further, the diameter of each cell 32 of 3 mm or less increases a contact area with the catalyst, so that the reaction efficiency can be improved. As used herein, the diameter of each cell 32 means a length of a portion having the maximum diameter.

Each partition wall 33 preferably has a thickness of from 0.05 to 0.3 mm, and more preferably from 0.08 to 0.15 mm, although not particularly limited thereto. The thickness of each partition wall 33 of 0.05 mm or more can the strength to be ensured. Further, the thickness of each partition wall 33 of 0.3 mm or less can increase an amount of a raw material that can be fed into the cells 32.

The catalyst member 30 having the above structure can allow the reaction in the cells 32 to be carried out by charging the raw material into the cells 32. The catalyst member 30 can be used by both a batch method and a flow method, but it is particularly suitable for use in the flow method.

When the catalyst member 30 is used by the batch method, the cells 32 on the fluid outflow end face 31b are plugged to house the raw material in the cells 32, and the reaction is carried out. When the catalyst member 30 is used by the flow method, the raw material is continuously charged from the fluid inflow end face 31a to carry out the reaction in the cells 32, and the reaction product is continuously discharged from the fluid outflow end face 31b. In the catalyst member 30, the catalyst layer 13 is difficult to be separated from the polarization layer 12, so that the catalyst can be prevented from being contaminated in the reaction product in both the batch method and the flow method, and it is also difficult to deteriorate the catalyst function.

Further, the situation of the inside of the catalyst member 30 which is a reactor can be confirmed by configuring it such that the partition walls 33 which are the support 11 are translucent, and a part of the partition walls 33 does not include the polarization layer 12 and the catalyst layer 13, as in the catalyst member 20 according to Embodiment 2 of the present invention.

Similarly, the situation of the inside of the catalyst member 30 which is a reactor can be confirmed by configuring it such that at least a part of the partition walls 33, the polarization layer 12, and the catalyst layer 13 is translucent.

When the raw material used for the reaction is a gas, the partition walls 33 and the outer peripheral wall 34 of the honeycomb structure are preferably formed of a material that does not allow the gas to permeate. Examples of such a material include metals, silica, polyethylene, polystyrene and the like.

Further, when the raw material used for the reaction is a liquid, the partition walls 33 and the outer peripheral wall 34 of the honeycomb structure are preferably formed of a material that does not allow the liquid to penetrate, but allows the gas to penetrate. Such a configuration can allow the gas generated during the reaction to be separated through the outer peripheral wall 34. Examples of the material that does not allow the liquid to penetrate but allows the gas to penetrate include porous materials such as ceramics. Such porous materials can be obtained by controlling the pore size. More particularly, the pore diameter of the porous material may be made larger than the molecular diameter of the gas generated during the reaction and smaller than the molecular diameter of the raw material used during the reaction or the reaction product. The pore diameter of the porous material can be controlled by adjusting a type and mixing ratio of a component (for example, a pore former) used for preparing the porous material.

### Embodiment 4

A reactor according to Embodiment 4 of the present invention further includes a container for containing the catalyst member 10, 20, 30 according to Embodiments 1 to 3 of the present invention. Such a configuration can allow the catalyst member 10, 20, 30 to be shielded from the outside, so that a risk of damaging the catalyst member 10, 20, 30 by an impact from the outside can be reduced.

The container is not particularly limited as long as it can contain the catalyst member 10, 20, 30 and does not inhibit the reaction.

The container can be made of, for example, a metal, glass, a ceramic, a plastic, or the like.

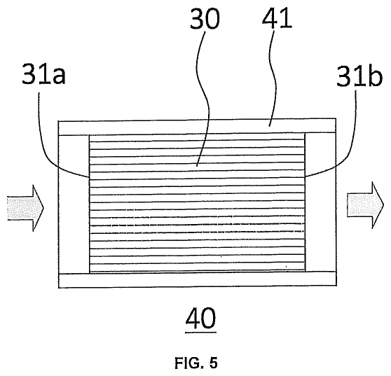

As an example of the reactor according to Embodiment 4 of the present invention, FIG. 5 shows a cross-sectional view of a reactor when the catalyst member 30 according to Embodiment 3 is used (a cross-sectional view parallel to the extending direction of the cells 32 of the catalyst member 30). It should be noted that in FIG. 5, the detailed structure of the catalyst member 30 is omitted for the sake of easy viewing.

As shown in FIG. 5, a reactor 40 includes: the catalyst member 30; and a tubular container 41 that covers the outer peripheral wall 34 of the catalyst member 30. When the reactor 40 is used in the flow method, the raw material is continuously charged from the fluid inflow end face 31a of the catalyst member 30 to carry out the reaction in the cells 32, and the reaction product is continuously discharged from the fluid outflow end face 31b of the catalyst member 30. In FIG. 5, the arrows indicate the flow direction of the raw material. Since the reactor 40 uses the catalyst member 30, the catalyst can be prevented from being contaminated in the reaction product, and it is difficult to deteriorate the catalyst function.

When the partition walls 33 of the catalyst member 30 are translucent and a part of the partition walls 33 do not include the polarization layer 12, and the catalyst layer 13, it is preferable that at least a part of the tubular container 41 is translucent. Such a configuration can allow the situation of the inside of the reactor 40 to be confirmed.

Similarly, when at least a part of the partition walls 33, the polarization layer 12 and the catalyst layer 13 of the catalyst member 30 is translucent, it is preferable that at least a part of the tubular container 41 is translucent. Such a configuration can allow the situation of the inside of the reactor 40 to be confirmed.

### DESCRIPTION OF REFERENCE NUMERALS

10, 20, 30 catalyst member
11 support
12 polarization layer
13 catalyst layer
31a fluid inflow end face
31b fluid outflow end face
32 cell
33 partition wall
34 outer peripheral wall
40 reactor
41 tubular container

1. A catalyst member comprising: a honeycomb support; a polarization layer provided on the support; and a catalyst layer provided on the polarization layer.

2. The catalyst member according to claim 1, wherein liquid raw materials can be charged.

3. The catalyst member according to claim 1, wherein the polarization layer is formed of a dielectric substance.

4. The catalyst member according to claim 1, wherein the catalyst layer comprises a catalyst having a metal.

5. The catalyst member according to claim 4, wherein the catalyst is a metal complex catalyst.

6. The catalyst member according to claim 5, wherein the metal complex catalyst is an asymmetric catalyst.

7. The catalyst member according to claim 1, wherein the support is formed of a ceramic.

8. The catalyst member according to claim 1, wherein the support is translucent, and a part of the support does not comprise the polarization layer and the catalyst layer.

9. The catalyst member according to claim 1, wherein at least a part of the support, the polarization layer and the catalyst layer is translucent.

10. A reactor comprising the catalyst member according to claim 1.

11. The reactor according to claim 10, further comprising a container for containing the catalyst member.

12. The reactor according to claim 11, wherein at least a part of the container is translucent.

13. The reactor according to claim 11, wherein the support of the catalyst member comprises partition walls and an outer peripheral wall, and the container is a tubular container covering the outer peripheral wall.

14. The reactor according to claim 10, wherein the reactor is used for flow synthesis.
